(19) United States
(12) Patent Application Publication
(10) Pub. No.: US 2016/0139298 A1
(43) Pub. Date: May 19, 2016

(54) Reservoir History Matching

(71) Applicant: LANDMARK GRAPHICS CORPORATION, Houston, TX (US)

(72) Inventors: Ajay Pratap Singh, Houston, TX (US); Jeffrey M Yarus, Houston, TX (US); Marko Maucec, Englewood, CO (US); Genbao Shi, Sugarland, TX (US)

(21) Appl. No.: 14/901,991

(22) PCT Filed: Jul. 29, 2013
(86) PCT No.: PCT/US13/52550

§ 371 Date: Dec. 29, 2015

(51) Int. Cl. G01V 99/00

(52) U.S. Cl. CPC G01V 99/005

(57) ABSTRACT

Systems and methods for reservoir history matching based on closed loop interaction between a geomodel and a reservoir model.

### CROSS-REFERENCE TO RELATED APPLICATIONS

Not applicable.

STATEMENT REGARDING FEDERALLY SPONSORED RESEARCH

Not applicable.

### FIELD OF THE DISCLOSURE

The present disclosure generally relates to systems and methods for reservoir history matching. More particularly, the present disclosure relates to reservoir history matching based on closed loop interaction between a geomodel and a reservoir model.

### BACKGROUND

Construction of geomodels often depends on the availability of rock property logs. Because logging wells may be sparsely located, geomodeling software is used to interpolate and/or extrapolate rock properties from the available rock property logs based on variogram definitions. When this type of geomodel is used in a reservoir model, a mismatch in the actual production data (e.g. oil, water and gas, BHP) and the simulated production data is often observed. To eliminate a mismatch, history matching is normally performed. In the history matching process, a reservoir engineer adjusts the reservoir model by manipulating physical properties of the reservoir such as, for example, porosity, permeability, relative permeability, net-to-gross (NTG), and skin factors. History matching in this manner can be manually performed based on some basic rules and guidelines or automatically performed based on probabilistic algorithms often referred to as assisted history matching (AHM) algorithms. None of the AHM algorithms, however, directs feedback from a reservoir simulator dynamic response to modify the geomodel input parameters and generate geomodel realizations that can reduce any mismatch between the simulated production data and the actual production data.

### BRIEF DESCRIPTION OF THE DRAWINGS

The present disclosure is described below with references to the accompanying drawings in which like elements are referenced with like reference numerals, and in which:

FIG. 1 is a flow diagram illustrating one embodiment of a method for implementing the present disclosure.

FIG. 2 is a graphical display illustrating a comparison between watercut profiles for 40 reservoir model realizations and actual watercut profiles for a production well as a result of the history matching performed in step 104 of FIG. 1.

FIG. 3 is a three-dimensional display of streamline trajectories connecting production wells (W1-W5) with an injection well (I1) as a result of the identification in step 112 of FIG. 1.

FIG. 4 is block diagram illustrating one embodiment of a computer system for implementing the present disclosure.

### DETAILED DESCRIPTION OF THE PREFERRED EMBODIMENTS

The present disclosure therefore, overcomes one or more deficiencies in the prior art by providing systems and methods for reservoir history matching based on closed loop interaction between a geomodel and a reservoir model.

In one embodiment, the present disclosure includes a method for reservoir history matching, which comprises: a) performing history matching by calculating a mismatch for multiple realizations of a geomodel based on actual well logs for a group of production wells in a reservoir; b) selecting a production well from the group of production wells in the reservoir that has not met a history matching goal; c) creating a pseudo well log along one or more streamline trajectories for a rock property using a computer system, the one or more streamline trajectories connecting the selected production well with at least one of an injection well, an aquifer and a gas cap for one of the multiple realizations that is a basis of a best history match for the selected production well with actual production data for the reservoir; d) repeating steps b) and c) for each production well in the group of production wells that has not met the history matching goal; and e) generating multiple new realizations for the geomodel using the pseudo well log(s) and the actual well logs for the group of production wells.

In another embodiment, the present disclosure includes a non-transitory program carrier device tangibly carrying computer executable instructions for reservoir history matching, the instructions being executable to implement: a) performing history matching by calculating a mismatch for multiple realizations of a geomodel based on actual well logs for the group of production wells in a reservoir; b) selecting a production well from the group of production wells in the reservoir that has not met a history matching goal; c) creating a pseudo well log along one or more streamline trajectories for a rock property, the one or more streamline trajectories connecting the selected production well with at least one of an injection well, an aquifer and a gas cap for one of the multiple realizations that is a basis of a best history match for the selected production well with actual production data for the reservoir; d) repeating steps b) and c) for each production well in the group of production wells that has not met the history matching goal; and e) generating multiple new realizations for the geomodel using the pseudo well log(s) and the actual well logs for the group of production wells.

In yet another embodiment, the present disclosure includes a non-transitory program carrier device tangibly carrying computer executable instructions for reservoir history matching, the instructions being executable to implement: a) performing history matching by calculating a mismatch for multiple realizations of a geomodel based on actual well logs for a group of production wells in a reservoir; b) selecting a production well from the group of production wells in the reservoir that has not met a history matching goal; c) creating a pseudo well log along one or more streamline trajectories for a rock property, the one or more streamline trajectories connecting the selected production well with an injection well for one of the multiple realizations that is a basis of a best history match for the selected production well with actual production data for the reservoir; d) repeating steps b) and c) for each production well in the group of production wells that has not met the history matching goal; e) generating multiple new realizations for the geomodel using the pseudo well log(s) and the actual well logs for the group of production wells; and f) repeating at least one of steps a) and b)-e) until each production well in the group of production wells has met the history matching goal.

The subject matter of the present disclosure is described with specificity, however, the description itself is not intended to limit the scope of the disclosure. The subject matter thus, might also be embodied in other ways, to include different steps or combinations of steps similar to the ones described herein, in conjunction with other technologies. Moreover, although the term “step” may be used herein to describe different elements of methods employed, the term should not be interpreted as implying any particular order among or between various steps herein disclosed unless otherwise expressly limited by the description to a particular order. While the following description refers to the oil and gas industry, the systems and methods of the present disclosure are not limited thereto and may also be applied in other industries to achieve similar results.

### Method Description

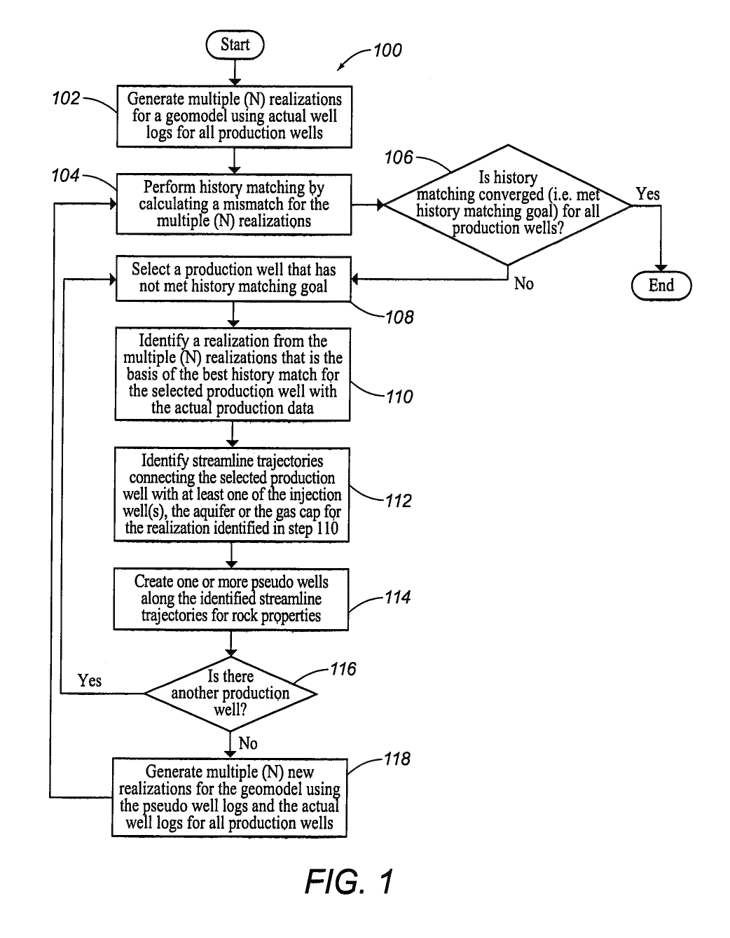

Referring now to FIG. 1, a flow diagram of one embodiment of a method 100 for implementing the present disclosure is illustrated.

In step 102, multiple (N) realizations are generated for a geomodel using actual well logs for all production wells and techniques well known in the art for generating a geomodel. A realization represents a model of a reservoir's physical property and an actual well log represents the measured physical property of the reservoir.

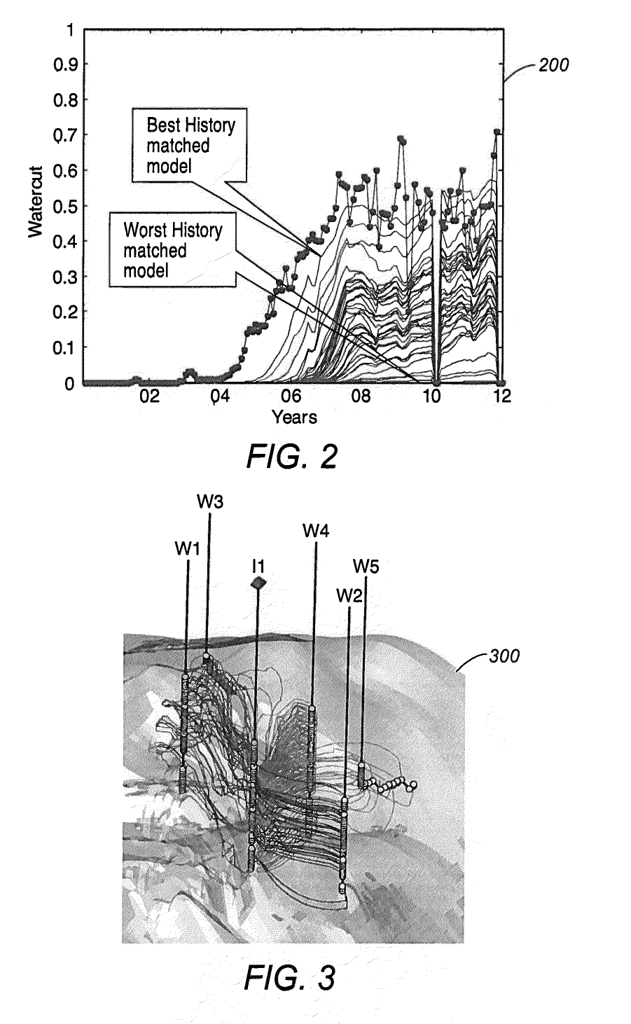

In step 104, history matching is performed by calculating a mismatch for the multiple (N) realizations. The mismatch is calculated by comparing actual production data and simulated production data using reservoir simulation models that are based on the multiple (N) realizations. In FIG. 2, a graphical display 200 illustrates an example of visualizing a mismatch by a comparison between watercut profiles for 40 reservoir model realizations and actual watercut profiles for a production well. Depending on the source of reservoir energy (active aquifer or large gas cap) and the type of injection well (water or gas), the actual production data for history matching will either be watercut profiles or gas oil ratio profiles from oil, water and gas production.

In step 106, the method 100 determines if the history matching performed in step 104 is converged for all production wells based on a predetermined history matching goal. If the history matching is converged, then the method 100 ends. If the history matching is not converged, then the method 100 proceeds to step 108. In FIG. 2, for example, history matching is not converged because the history matching goal requires a smaller variation between the watercut profiles for the 40 reservoir model realizations and the actual watercut profiles for the production well.

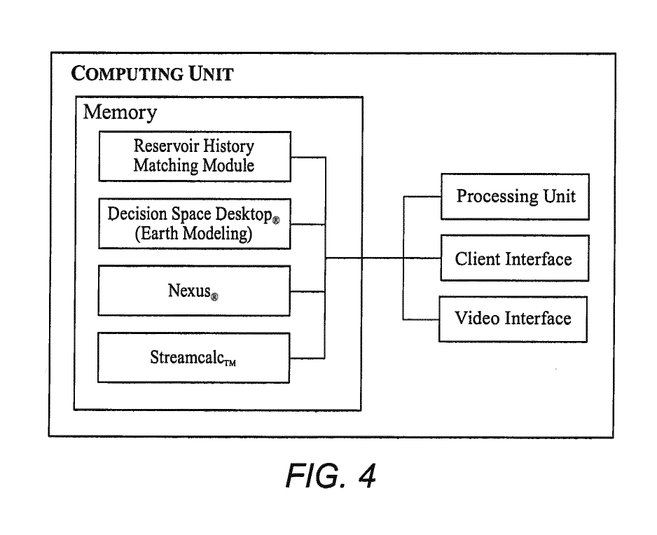

In step 108, a production well that has not met the history matching goal is automatically selected from the group of all production wells or it may be manually selected using the client interface and/or the video interface described further in reference to FIG. 4.

In step 110, a realization from the multiple (N) realizations is automatically identified that is the basis of the best history match for the selected production well with the actual production data (e.g. watercut profiles or gas oil ratio profiles) using techniques well known in the art. One technique, for example, compares the sum of the squared error calculated at each recorded actual production data between the actual production data and the simulated production data. The best history match is the realization that is the basis of the lowest sum of the squared error comparison.

In step 112, streamline trajectories connecting the selected production well with at least one of the injection well(s), the aquifer or the gas cap are identified for the realization identified in step 110 using streamline calculations and techniques well known in the art. In FIG. 3, a three-dimensional display 300 illustrates an example of streamline trajectories connecting production wells (W1-W5) with an injection well (I1) after five (5) iterations of the method 100.

In step 114, one or more pseudo well logs are created along the identified streamline trajectories for rock properties such as, for example, porosity, permeability, relative permeability, and net-to-gross (NTG), using one or more of the available rock properties from one or more grid cells along the identified streamline trajectories. In general, all grid cells along the identified streamline trajectories may be used, or just a few of them, to create the pseudo well logs.

In step 116, the method 100 determines if there is another production well in the group of all production wells that has not been processed according to steps 110-114. If there is another production well that has not been processed according to steps 110-114, then the method 100 returns to step 108. If there is not another production well that has not been processed according to steps 110-114, then the method 100 proceeds to step 118.

In step 118, multiple (N) new realizations are generated for the geomodel using the actual well logs and the pseudo well log(s) for all production wells and techniques well known in the art for generating the geomodel. In this manner, the history matching performed in step 104 may be improved toward the convergence goal. The closed loop interaction between the geomodel in step 118 and the reservoir model in step 104 therefore, improves history matching performance by: i) providing a direct connection between the geomodel and the reservoir model's dynamic response; ii) enabling quicker convergence; iii) reducing the need for a high computational load during the history matching process as convergence is faster; and iv) improving uncertainty quantification of reservoir characterization.

### System Description

The present disclosure may be implemented through a computer-executable program of instructions, such as program modules, generally referred to as software applications or application programs executed by a computer. The software may include, for example, routines, programs, objects, components and data structures that perform particular tasks or implement particular abstract data types. The software forms an interface to allow a computer to react according to a source of input. PecisionSpace Desktop®, which is a commercial software application marketed by Landmark Graphics Corporation, may be used as an interface application to implement the present disclosure. The software may also cooperate with other code segments to initiate a variety of tasks in response to data received in conjunction with the source of the received data. The software may be stored and/or carried on any variety of memory such as CD-ROM, magnetic disk, bubble memory and semiconductor memory (e.g., various types of RAM or ROM). Furthermore, the software and its results may be transmitted over a variety of carrier media such as optical fiber, metallic wire and/or through any of a variety of networks, such as the Internet.

Moreover, those skilled in the art will appreciate that the disclosure may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present disclosure. The disclosure may be practiced in distributed-computing environments where tasks are performed by remote-processing devices that are linked through a communications network. In a distributed-computing environment, program modules may be located in both local and remote computer-storage media including memory storage devices. The present disclosure may therefore, be implemented in connection with various hardware, software or a combination thereof, in a computer system or other processing system.

Referring now to FIG. 4, a block diagram illustrates one embodiment of a system for implementing the present disclosure on a computer. The system includes a computing unit, sometimes referred to as a computing system, which contains memory, application programs, a client interface, a video interface, and a processing unit. The computing unit is only one example of a suitable computing environment and is not intended to suggest any limitation as to the scope of use or functionality of the disclosure.

The memory primarily stores the application programs, which may also be described as program modules containing computer-executable instructions, executed by the computing unit for implementing the present disclosure described herein and illustrated in FIGS. 1-3. The memory therefore, includes a reservoir history matching module, which enables steps 106-116 described in reference to FIG. 1. The reservoir history matching module may integrate functionality from the remaining application programs illustrated in FIG. 4. In particular, DecisionSpace Desktop® may be used as an interface application to perform steps 102 and 118 in

FIG. 1. In addition, Nexus® and Streamcalc™, which are commercial software applications marketed by Landmark Graphics Corporation, may also be used as interface applications to perform step 104 and the streamline calculations used in step 112 of FIG. 1, respectively.

Although DecisionSpace Desktop®, Nexus® and Streamcalc™ may be used as interface applications, other interface applications may be used, instead, or the reservoir history matching module may be used as a stand-alone application.

Although the computing unit is shown as having a generalized memory, the computing unit typically includes a variety of computer readable media. By way of example, and not limitation, computer readable media may comprise computer storage media and communication media. The computing system memory may include computer storage media in the form of volatile and/or nonvolatile memory such as a read only memory (ROM) and random access memory (RAM). A basic input/output system (MOS), containing the basic routines that help to transfer information between elements within the computing unit, such as during start-up, is typically stored in ROM. The RAM typically contains data and/or program modules that are immediately accessible to, and/or presently being operated on, the processing unit. By way of example, and not limitation, the computing unit includes an operating system, application programs, other program modules, and program data.

The components shown in the memory may also be included in other removable/nonremovable, volatile/nonvolatile computer storage media or they may be implemented in the computing unit through an application program interface (“API”) or cloud computing, which may reside on a separate computing unit connected through a computer system or network. For example only, a hard disk drive may read from or write to nonremovable, nonvolatile magnetic media, a magnetic disk drive may read from or write to a removable, nonvolatile magnetic disk, and an optical disk drive may read from or write to a removable, nonvolatile optical disk such as a CD ROM or other optical media. Other removable/non-removable, volatile/nonvolatile computer storage media that can be used in the exemplary operating environment may include, but are not limited to, magnetic tape cassettes, flash memory cards, digital versatile disks, digital video tape, solid state RAM, solid state RPM, and the like. The drives and their associated computer storage media discussed above provide storage of computer readable instructions, data structures, program modules and other data for the computing unit.

A client may enter commands and information into the computing unit through the client interface, which may be input devices such as a keyboard and pointing device, commonly referred to as a mouse, trackball or touch pad. Input devices may include a microphone, joystick, satellite dish, scanner, or the like. These and other input devices are often connected to the processing unit through the client interface that is coupled to a system bus, but may be connected by other interface and bus structures, such as a parallel port or a universal serial bus (USB).

A monitor or other type of display device may be connected to the system bus via an interface, such as a video interface. A graphical user interface (“GUI”) may also be used with the video interface to receive instructions from the client interface and transmit instructions to the processing unit. In addition to the monitor, computers may also include other peripheral output devices such as speakers and printer, which may be connected through an output peripheral interface.

Although many other internal components of the computing unit are not shown, those of ordinary skill in the art will appreciate that such components and their interconnection are well known.

While the present disclosure has been described in connection with presently preferred embodiments, it will be understood by those skilled in the art that it is not intended to limit the disclosure to those embodiments. It is therefore, contemplated that various alternative embodiments and modifications may be made to the disclosed embodiments without departing from the spirit and scope of the disclosure defined by the appended claims and equivalents thereof.

1. A method for reservoir history matching, which comprises:
a) performing history matching by calculating a mismatch for multiple realizations of a geomodel based on actual well logs for a group of production wells in a reservoir;
b) selecting a production well from the group of production wells in the reservoir that has not met a history matching goal;
c) creating a pseudo well log along one or more streamline trajectories for a rock property using a computer system, the one or more streamline trajectories connecting the selected production well with at least one of an injection well, an aquifer and a gas cap for one of the multiple realizations that is a basis of a best history match for the selected production well with actual production data for the reservoir;
d) repeating steps b) and c) for each production well in the group of production wells that has not met the history matching goal; and
e) generating multiple new realizations for the geomodel using the pseudo well logs) and the actual well logs for the group of production wells.

2. The method of claim 1, further comprising repeating at least one of steps a) and b)-e) until each production well in the group of production wells has met the history matching goal.

3. The method of claim 1, wherein the mismatch is calculated by comparing the actual production data for the reservoir and simulated production data using reservoir simulation models that are based on the multiple realizations.

4. The method of claim 1, wherein the actual production data represents actual watercut profiles or actual gas oil ratio profiles.

5. The method of claim 1, wherein the one or more streamline trajectories are based on a respective streamline calculation.

6. The method of claim 1, wherein the rock property represents porosity, permeability, relative permeability or net-to-gross.

7. The method of claim 1, wherein the pseudo well log is created using the rock property from one or more grid cells along a respective streamline trajectory.

8. A non-transitory program carrier device tangibly carrying computer executable instructions for reservoir history matching, the instructions being executable to implement:
a) performing history matching by calculating a mismatch for multiple realizations of a geomodel based on actual well logs for the group of production wells in a reservoir;
b) selecting a production well from the group of production wells in the reservoir that has not met a history matching goal;
c) creating a pseudo well log along one or more streamline trajectories for a rock property, the one or more streamline trajectories connecting the selected production well with at least one of an injection well, an aquifer and a gas cap for one of the multiple realizations that is a basis of a best history match for the selected production well with actual production data for the reservoir;
d) repeating steps b) and c) for each production well in the group of production wells that has not met the history matching goal; and
e) generating multiple new realizations for the geomodel using the pseudo well log(s) and the actual well logs for the group of production wells.

9. The program carrier device of claim 8, further comprising repeating at least one of steps a) and b)-e) until each production well in the group of production wells has met the history matching goal.

10. The program carrier device of claim 8, wherein the mismatch is calculated by comparing the actual production data for the reservoir and simulated production data using reservoir simulation models that are based on the multiple realizations.

11. The program carrier device of claim 8, wherein the actual production data represents actual watercut profiles or actual gas oil ratio profiles.

12. The program carrier device of claim 8, wherein the one or more streamline trajectories are based on a respective streamline calculation.

13. The program carrier device of claim 8, wherein the rock property represents porosity, permeability, relative permeability or net-to-gross.

14. The method of claim 8, wherein the pseudo well log is created using the rock property from one or more grid cells along a respective streamline trajectory

15. A non-transitory program carrier device tangibly carrying computer executable instructions for reservoir history matching, the instructions being executable to implement:
a) performing history matching by calculating a mismatch for multiple realizations of a geomodel based on actual well logs for a group of production wells in a reservoir;
b) selecting a production well from the group of production wells in the reservoir that has not met a history matching goal;
c) creating a pseudo well log along one or more streamline trajectories for a rock property, the one or more streamline trajectories connecting the selected production well with an injection well for one of the multiple realizations that is a basis of a best history match for the selected production well with actual production data for the reservoir;
d) repeating steps b) and c) for each production well in the group of production wells that has not met the history matching goal;
e) generating multiple new realizations for the geomodel using the pseudo well log(s) and the actual well logs for the group of production wells; and
f) repeating at least one of steps a) and b)-e) until each production well in the group of production wells has met the history matching goal.

16. The program carrier device of claim 15, wherein the mismatch is calculated by comparing the actual production data for the reservoir and simulated production data using reservoir simulation models that are based on the multiple realizations.

17. The program carrier device of claim 15, wherein the actual production data represents actual watercut profiles or actual gas oil ratio profiles.

18. The program carrier device of claim 15, wherein the one or more streamline trajectories are based on a respective streamline calculation.

19. The program carrier device of claim 15, wherein the rock property represents porosity, permeability, relative permeability or net-to-gross.

20. The program carrier device of claim 15, wherein the pseudo well log is created using the rock property from one or more grid cells along a respective streamline trajectory.
